(19) United States
(12) Patent Application Publication
(10) Pub. No.: US 2015/0103961 A1
(43) Pub. Date: Apr. 16, 2015

(54) DIGITAL FREQUENCY BAND DETECTOR FOR CLOCK AND DATA RECOVERY

(71) Applicant: LSI Corporation, San Jose, CA (US)

(72) Inventors: Amaresh V. Malipatil, San Jose, CA (US); Shiva Prasad Kotagiri, Campbell, CA (US); Sundeep Venkatraman, San Jose, CA (US); Sunil Srinivasa, Santa Clara, CA (US); Pervez M. Aziz, Dallas, TX (US)

(73) Assignee: LSI Corporation, San Jose, CA (US)

(21) Appl. No.: 14/053,069

(22) Filed: Oct. 14, 2013

(51) Int. Cl. H04L 7/00; H04L 25/03

(52) U.S. Cl. CPC H04L 7/0016; H04L 7/0079; H04L 25/03057
USPC 375/355

(57) ABSTRACT

A frequency band estimator for use in a data receiver or the like to enhance sinusoidal jitter tolerance by the clock and data recovery device (CDR) in the receiver. The detector uses two moving-average filters of different tap lengths that receive a gain-controlled signal from within the CDR. Output signals from the moving average filters are processed to determine a half-wave time period for each output signal by measuring the number clock cycles occurring between transitions of each output signal. The number of clock cycles of the longest half-wave period is compared to multiple values representing frequency limits of various frequency bands to determine which frequency band to classify jitter the gain-controlled signal. The determined frequency band is used to select from a look-up table a set of gain values for use in the CDR.

### FIELD OF THE INVENTION

The present invention relates to receivers generally and, more specifically, to clock and data recovery circuitry therein.

### BACKGROUND

Communication receivers that recover digital signals must sample an analog waveform and then reliably detect the sampled data. Signals arriving at a receiver are typically corrupted by intersymbol interference (ISI), crosstalk, echo, and other noise. As data rates increase, the receiver must both equalize the channel, to compensate for such corruptions, and detect the encoded signals at increasingly higher clock rates. Decision-feedback equalization (DFE) is a widely used technique for removing intersymbol interference and other noise at high data rates.

Generally, decision-feedback equalization utilizes a nonlinear equalizer to equalize the channel using a feedback loop based on previously recovered (or decided) data. In one typical DFE-based receiver implementation, a received analog signal is sampled in response to a data-sampling clock after DFE correction and compared to one or more thresholds to generate the recovered data.

To acquire the correct clock phase and properly sample incoming data signals in the center of the data “eye” opening, a clock and data recovery (CDR) circuit derives the correct clock phase by “locking” onto transitions in the incoming data signals. To compensate for jitter in the incoming data signals, the CDR might be implemented as a second-order CDR having a proportional term and an integral term in the transfer function of the CDR. To tailor the transfer function to meet certain requirements (e.g., jitter response) of the application using the CDR, analog CDR implementations rely on the adjustment of component values such as resistances, currents, capacitances, etc. to meet the desired requirements. However, the value of the components are dependent on temperature and operating voltage, and manufacturing process variations might make CDRs made under certain process “corners” incapable of operating with the desired requirements. Moreover, the component values can change over time, causing working devices to eventually fail.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment of the invention, a frequency band detector comprises an input node, first and second low-pass filters, first and second time period estimators, and a frequency band discriminator. The first low-pass filter, coupling to the input node, has a first cutoff frequency and an output, and the second low-pass filter, coupling to the input node, has an output and a second cutoff frequency less than the first cutoff frequency. The first time period estimator has an output and an input coupled to the output of the first low-pass filter, configured to output a first time period measurement for samples from the output of the first low-pass filter to transition a first threshold and then transition a second threshold. The second time period estimator has an output and an input to the output of the second low-pass filter, configured to output a second time period measurement for samples from the output of the second low-pass filter to transition a third threshold and then transition a fourth threshold. The frequency band discriminator is configured to select the greater of the first and second time period measurements; and compare the selected time period measurement to at least one limit value, the limit value related to a first frequency band. An input signal applied to the input node has a frequency in the first frequency band if the selected time period measurement is less than the limit value.

### BRIEF DESCRIPTION OF THE DRAWINGS

Other embodiments of the present invention will become more fully apparent from the following detailed description, the appended claims, and the accompanying drawings in which like reference numerals identify similar or identical elements.

FIG. 1 is a simplified block diagram of a clock and data recovery circuit usable in a serializer/deserializer (SERDES) communication system incorporating a sinusoidal jitter band detector according to one embodiment of the invention;

FIG. 2 is an exemplary look-up table having entries of various CDR gains based on the sinusoidal jitter frequency band determined by the sinusoidal jitter frequency band detector of FIGS. 1 and 3; and

FIG. 3 is a simplified block diagram of the sinusoidal jitter band detector of FIG. 1;

FIG. 4 is an exemplary signal filtered by a low-pass filter in FIG. 3; and

FIG. 5 is a simplified flow diagram illustrating an exemplary operation of the sinusoidal jitter band detector of FIG. 2.

### DETAILED DESCRIPTION

In addition to the patents referred to herein, each of the following patents and patent applications are incorporated herein in their entirety:
U.S. Pat. No. 7,616,686, titled “Method and Apparatus for Generating One or More Clock Signals for a Decision-Feedback Equalizer Using DFE Detected Data”, by Aziz et al.
U.S. Pat. No. 7,599,461, titled “Method and Apparatus for Generating One or More Clock Signals for a Decision-Feedback Equalizer Using DFE Detected Data in the Presence of an Adverse Pattern”, by Aziz et al.
U.S. Pat. No. 7,421,050, titled “Parallel Sampled Multi-Stage Decimated Digital Loop Filter for Clock/Data Recovery”, by Aziz et al.
U.S. Pat. No. 7,916,822, titled “Method and Apparatus for Reducing Latency in a Clock and Data Recovery (CDR) Circuit”, by Aziz et al.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation”.

It should be understood that the steps of the exemplary methods set forth herein are not necessarily required to be performed in the order described, and the order of the steps of such methods should be understood to be merely exemplary. Likewise, additional steps might be included in such methods, and certain steps might be omitted or combined, in methods consistent with various embodiments of the present invention.

Also for purposes of this description, the terms “couple”, “coupling”, “coupled”, “connect”, “connecting”, or “connected” refer to any manner known in the art or later developed in which energy is allowed to transfer between two or more elements, and the interposition of one or more additional elements is contemplated, although not required. Conversely, the terms “directly coupled”, “directly connected”, etc., imply the absence of such additional elements. Signals and corresponding nodes or ports might be referred to by the same name and are interchangeable for purposes here. The term “or” should be interpreted as inclusive unless stated otherwise. Further, elements in a figure having subscripted reference numbers (e.g., 100₁, 100₂, . . . 100_{K}) might be collectively referred to herein using the reference number 100.

The present invention will be described herein in the context of illustrative embodiments of a sinusoidal jitter frequency band detection circuit adapted for use in a clock and data recovery device in a digital data receiver or the like. It is to be appreciated, however, that the invention is not limited to the specific apparatus and methods illustratively shown and described herein.

As data rates increase for serializer/deserializer (SERDES) applications, the channel quality degrades. Decision feedback equalization (DFE) in conjunction with an optional finite impulse response (FIR) filter in a transmitter (TX) and an analog equalizer within the receiver is generally used to achieve the bit error rate (BER) performance needed for reliable communications. A clock and data recovery (CDR) circuit or device is provided to extract clock signals for properly sampling received signals to extract data for further processing in conjunction with the DFE.

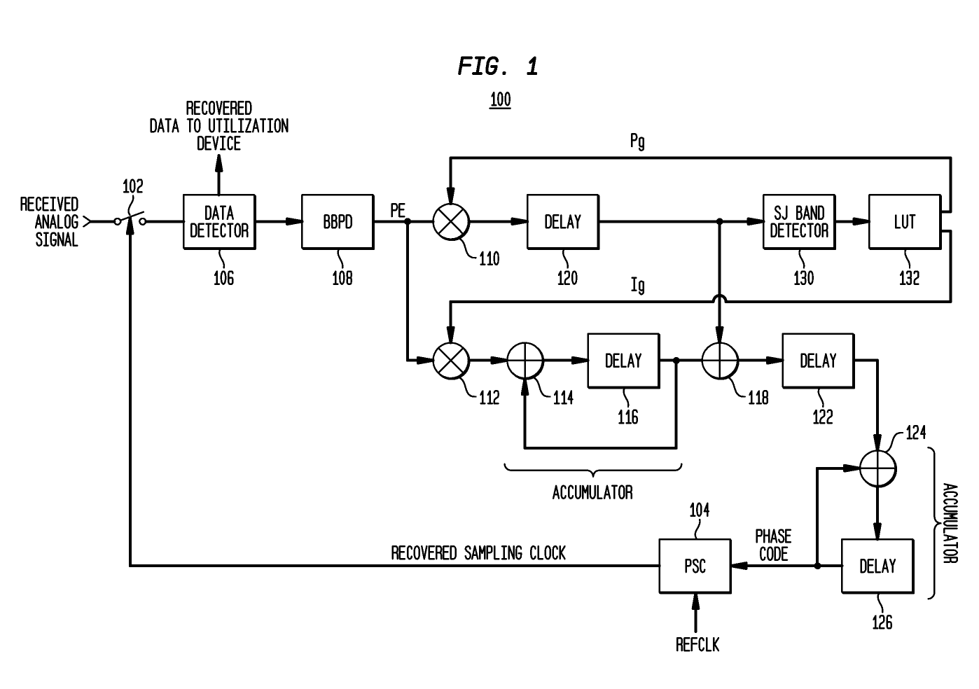

FIG. 1 is a block diagram of a second-order CDR 100 in accordance with one embodiment of the invention. Operation of the CDR 100 can be understood generally from the above-identified U.S. Pat. No. 7,916,822. Briefly as described herein, a received analog signal is sampled by sampler in response to a recovered sampling clock signal from a phase-shift controller (PSC) 104. The phase of the analog waveform applied to sampler 102 is typically unknown and there may be a phase/frequency offset between the frequency at which the original data was transmitted and the nominal receiver sampling clock frequency. The function of the PSC 104 is to properly sample the analog waveform such that when the sampled waveform is passed through a slicer, the data is recovered properly despite the fact that the phase and frequency of the transmitted signal is not known. For purposes here, the PSC selects or generates a clock phase from a reference clock (REFCLK) in response to a phase code and, as will be described in more detail below, the rest of the CDR 100 adaptively adjusts the phase of a nominal reference clock signal to produce the recovered sampling clock that the sampler 102 uses to sample the analog waveform to allow proper data detection.

The analog signal applied to sampler 102 might come from a transmission medium (transmission line, backplane traces, etc.) with our without analog equalization.

A data decoder 106, which might include the aforementioned DFE (not shown), processes the samples from sampler 102 to recover data to use by a utilization device such as a computer. The data detector 106 also provides transition samples (typically samples in quadrature to the samples used to provide the recovered data) that are sent to a bang-bang phase detector (BBPD) 108. Bang-bang phase detectors are well known and other phase detectors other than a BBPD might be used and might be implemented using look-up tables. For a general discussion of bang-bang phase detectors, see, for example, J. D. H. Alexander, “Clock Recovery from Random Binary Signals,” Electronics Letters, 541-42 (October, 1975), incorporated by reference herein in its entirety. The delays as used here might be implemented as a register clocked by a clock from the PSC 104 (not shown).

In one embodiment and as is known in the art, the data detectors 106 and BBPD 108 can represent an array of parallel data detectors and phase detectors and an adder or “majority vote” function to combine the outputs of the parallel phase detectors. Phase error (PE) samples from BBPD 108 is applied to variable gain stages 110 and 112, here implemented as multipliers or by using shift registers, the amount of shift determining the “gain” provided by the shift registers. The gain provided by the multipliers 110, 112 (or shift provided by shift registers) are denoted here as Pg (proportional path gain) for multiplier 110 and Ig (integral path gain) for multiplier 112.

Gain-adjusted phase error samples from multiplier 112 are accumulated (integrated) by summer 114 and delay 116, the accumulated sample values from delay 116 applied to summer 118. Similarly, gain-adjusted phase error samples from multiplier 110 are delayed by delay 120 and applied to the summer 118. The delay 120 is the proportional path delay and delay 116 is the integral path delay. For purposes here, multiplier 110 and delay 120 are referred to as the proportional path of the second-order CDR 100, and the multiplier 112, summer 114, and delay 116 are referred to as the integral path of the second-order CDR 100.

The summed proportional path samples and integral path samples from summer 118 are delayed by delay 122, representing the latency associated with summer 118, and accumulated by the combination of summer 124 and delay 126 to generate the phase code needed by PSC 104 to produce the correct recovered sampling phase clock to sampler 102, thus forming a second-order loop to extract the correct sampling clock phase.

When the CDR 100 is used in certain applications defined by various standards, such as PCI-Express Gen 3 and serial-attached storage (SAS) version 3, the applicable standard specifies how the CDR responds to sinusoidal jitter (SJ) in received data signals and this response is usually frequency dependent. One approach to address the SJ requirements of the standard is to adjust the proportional and integral loop gains in the CDR depending on the frequency of the SJ. Analog techniques discussed above are process, temperature, and operating voltage sensitive, meaning that reliable manufacturable designs are difficult to implement. By using an all-digital CDR, compact, low power stable designs are possible with programmable functionality that can be tailored to the desired application to meet the relevant standard such as the aforementioned sinusoidal jitter requirements.

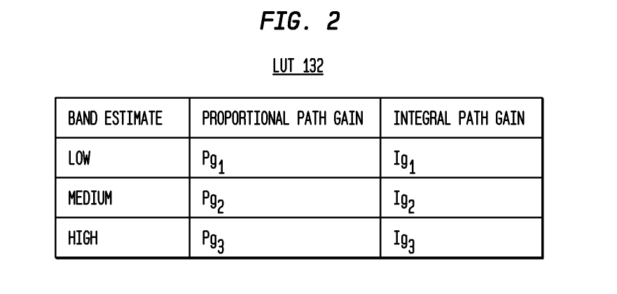

To allow for an all-digital design that can handle sinusoidal jitter, a digital SJ frequency band detector 130 responsive to the output of the delay 120, determines the frequency of any SJ in the received analog signal. Depending on which frequency band the SJ is determined to be in, a look-up table (LUT) 132 takes the frequency band data and provides the proportional path gain value Pg to multiplier 110 and the integral path gain value Ig to the multiplier 112. An example of a LUT 132 is shown in FIG. 2 for different frequency bands, here bands high, medium, and low. In alternative embodiments, two bands are used or, in still another embodiment, more than three bands are used. It is understood that other techniques than the LUT might be used to generate the various gains, such as by an algorithm. For the LUT 132, the gain terms might be determined by modeling the CDR under various jitter and signal conditions to find those gain amounts that achieve the desired requirements for the CDR 100.

While the SJ frequency band detector 130 is shown coupled to the delay 120, the input of the detector 130 might be instead coupled to, for example, the output of the multiplier 110, multiplier 112, delay 116, summer 118, delay 122, or delay 126, etc. Signals from these elements contain the SJ to be detected by the detector 130.

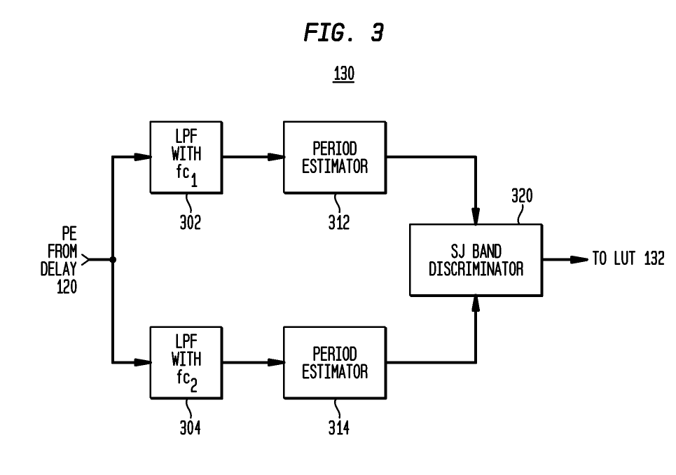

FIG. 3 illustrates an exemplary sinusoidal jitter frequency band detector 130 according to one embodiment of the invention. Two low-pass filters (LPF) 302, 304 receive gain-adjusted proportional path samples from delay 120 (FIG. 1). Here, LPF 304 has a cutoff frequency fc₂ that is lower in frequency than a cutoff frequency fc₁ of LPF 302. In one embodiment, the LPF 302 and 304 are implemented in digital form as moving-average filters, with LPF 304 having more taps than LPF 302. As is well known in the art, a moving-average filter has a transfer function of:

H(f)=(sin(πfM))/(M sin(πf));

where M is the number of unity-weighted taps. As evident from the above equation, the more the taps, the lower the cutoff frequency of the filter. In one specific embodiment, the LPF 302 has sixteen taps while LPF 304 has one hundred twenty eight (128) taps. In this embodiment, the ratio of the number of taps in one LPF to the other LPF should be based on the ratio of the frequency band boundary between the low and medium frequency bands and the frequency band boundary between the medium and high frequency bands. As will be evident, which LPF has the lowest cutoff frequency is not critical.

The LPFs 302, 304 filter out high frequency content so that the SJ frequency can be better estimated from the filter outputs. For lower SJ frequencies, the output of the LPF 304 contains more reliable information of the SJ frequency than the output of the LPF 304 because the LPF 304 passes higher frequency noise. For higher SJ frequencies, the output of LPF 304 contains more reliable information of SJ frequency than the output of LPF 302 because LPF 302 attenuates higher SJ frequency content.

Outputs from the LPFs couple to corresponding time period estimators 312, 314. The period estimators measure the time duration between threshold crossings (a threshold of zero in one embodiment but other thresholds can be used as will be explained in more detail below) of the respective LPF outputs over a long period of time and might be averaged. The average duration between zero crossings is an estimate of the SJ period. The time duration is measured in the number of clock cycles between threshold crossings, referred to herein as transitions, and can be measured in units proportional to the number of clock cycles, such as interval units. It is generally desirable that the frequency of the clock being counted is significantly greater than the highest SJ frequency to be measured, e.g., eight or more times the highest expected SJ frequency.

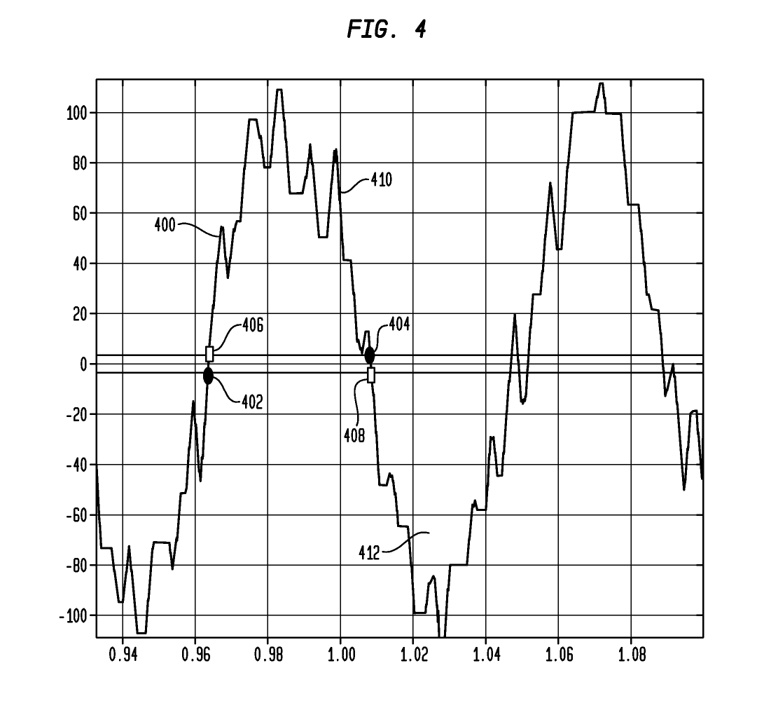

To reduce the effect of noise when counting between transitions, a hysteresis is added to the crossing detector (not shown) in each of the estimators 312, 314. In one embodiment, a positive threshold and a negative threshold is used as illustrated in FIG. 4. Here, clock cycles are counted when the amplitude of the plotted signal 400 is between the two circles 402, 404 or squares 406, 408. In this embodiment, circle 402 or square 406 represents a first threshold and circle 404 or square 408 represent a second threshold. In this example, circle 402 and square 408 have a value less than zero, and circle 404 and square 406 have a value greater than zero. In one exemplary embodiment, the difference between the first and second thresholds is eight or sixteen depending on the amplitude of the signals from the LPFs 302, 304. Further, the thresholds for estimator 312 might be different from the thresholds for estimator 314, such that there are four thresholds, two for each estimator 312, 314. In one embodiment, the thresholds are set in proportion to the gain Pg applied to multiplier 110 (FIG. 1). Each estimator 312, 314 outputs a time period measurement for a half-cycle, here half-cycle 410 but can also measure the time period of half-cycle 412.

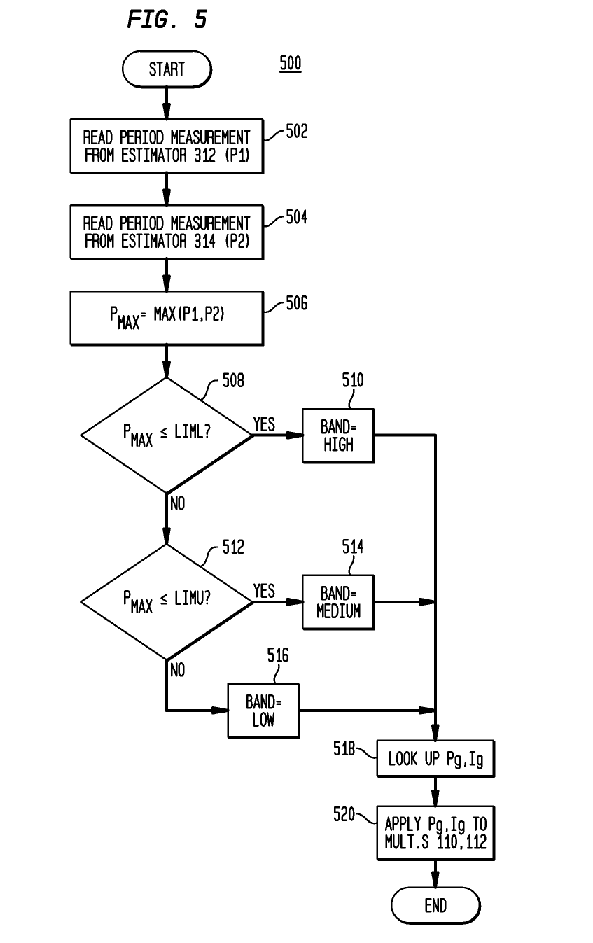

An SJ frequency band discriminator 320 receives the time period measurements from the time period estimators 312, 314 to estimate which one of a plurality of frequency bands the SJ should be classified as or “binned”. Operation of the discriminator 320 is illustrated in FIG. 5. The process 500 begins with steps 502 and 504 in which the discriminator 320 reads or receives the time period measurements, designated here as P1 and P2, from estimator 312 and 314, respectively. Then in step 506, the greater of the two time period measurements P1 and P1 is selected as Pmax. Next, Pmax is compared in step 508 to a first limit value. If Pmax is less than or equal to the limit LIML, then the SJ is determined to be in frequency band HIGH and the variable BAND is set to HIGH, and control passes to step 518. If Pmax is greater than LIML, then in step 512 Pmax is compared to a second limit value, LIMU, and if Pmax is less than or equal to LIMU, then in step 514 the variable BAND is set to MEDIUM, and control passes to step 518. However, if it is greater than LIMU, in step 516 the variable BAND is set to LOW, and control passes to step 518. In step 518, the appropriate values for gains Pg and Ig are fetched from the look-up table 132 such as the one shown in FIG. 4. Lastly, in step 520, the fetched gain values are applied to the corresponding multipliers 110, 112.

It is understood that the process 500 can be modified to bin the SJ in one of two frequency bands or more than three frequency bands. Further, the discriminator 320 might be implemented as a state machine or digital processor to execute the process 500. Still further, the processor might be further adapted to perform all the functions of blocks 302-314 and, if desired, the functions of one or more of the blocks in FIG. 1. However, due to the high-speed requirements of some of the functional blocks in FIG. 1, such as the data detector 106 and BBPD 108, these functions might be implemented in hardware instead of software running on a processor. Further, decimators (not shown) might be added to the CDR 100 to reduce the speed requirements of some of the functional blocks in FIG. 1.

It is further understood that the exemplary clock and data recovery arrangement described above is useful in applications other than in SERDES receivers, e.g., communications transmitters and receivers generally.

While embodiments have been described with respect to circuit functions, the embodiments of the present invention are not so limited. Possible implementations, either as a stand-alone SERDES or as a SERDES embedded with other circuit functions, may be embodied in or part of a single integrated circuit, a multi-chip module, a single card, system-on-a-chip, or a multi-card circuit pack, etc. but are not limited thereto. As would be apparent to one skilled in the art, the various embodiments might also be implemented as part of a larger system. Such embodiments might be employed in conjunction with, for example, a digital signal processor, microcontroller, field-programmable gate array, application-specific integrated circuit, or general-purpose computer. It is understood that embodiments of the invention are not limited to the described embodiments, and that various other embodiments within the scope of the following claims will be apparent to those skilled in the art.

It is understood that various changes in the details, materials, and arrangements of the parts which have been described and illustrated in order to explain the nature of this invention may be made by those skilled in the art without departing from the scope of the invention as expressed in the following claims.

1. An apparatus comprising:
an input node;
a first low-pass filter, coupled to the input node, having a first cutoff frequency and an output;
a second low-pass filter, coupled to the input node, having a second cutoff frequency less than the first cutoff frequency and an output;
a first time period estimator, having an output and an input coupled to the output of the first low-pass filter, configured to output a first time period measurement for samples from the output of the first low-pass filter to transition a first threshold and then transition a second threshold;
a second time period estimator, having an output and an input coupled to the output of the second low-pass filter configured to output a second time period measurement for samples from the output of the second low-pass filter to transition a third threshold and then transition a fourth threshold; and
a frequency band discriminator configured to:
select the greater of the first and second time period measurements; and compare the selected time period measurement to at least one limit value, the at least one limit value related to a first frequency band;
wherein an input signal applied to the input node has a frequency in the first frequency band if the selected time period measurement is less than the limit value.

2. The apparatus of claim 1, wherein the first through fourth thresholds are substantially zero.

3. The apparatus of claim 1, wherein the first and third threshold have substantially a value that is the same, and the second and fourth threshold have substantially a value that is less than the value of the first and third thresholds.

4. The apparatus of claim 1, wherein the first and third thresholds have substantially a same value that is the same, and the second and fourth thresholds have substantially a value that is greater than the value of the first and third thresholds.

5. The apparatus of claim 1, wherein the input signal has an amplitude, the first and third thresholds have substantially a value that is the same, and the second and fourth thresholds have substantially a value that is the same and differs from the value of the first and third thresholds by a selected amount.

6. The apparatus of claim 1, wherein each of the time period measurements is a number of clock cycles occurring between corresponding transitions.

7. The apparatus of claim 1, wherein the first low-pass filter is a moving-average filter and the second low-pass filter is a moving-average filter having more taps than the first filter.

8. The apparatus of claim 1, wherein the frequency band discriminator is implemented in a processor that also implements the first and second low-pass filters and the first and second time period estimators, and the input signal is a digital sampled signal.

9. The apparatus of claim 1, wherein the frequency band discriminator compares the selected time period measurement to a plurality of limit values related to a plurality of frequency bands, and the frequency band of the input signal applied to the input node is determined by the comparison of selected time period measurement to the plurality of limit values.

10. The apparatus of claim 1, wherein at least the input node, the first low-pass filter, the second low-pass filter, the first time period estimator, the second time period estimator, and the frequency band discriminator are components of an integrated circuit.

11. A method of determining a frequency of an input signal applied to an input node comprising the steps of:
filtering the input signal with a first low-pass filter having a cutoff frequency to produce a first filtered signal;
filtering the input signal with a second low-pass filter having a cutoff frequency less than the cutoff frequency of the first filter to produce a second filtered signal;
measuring a first time period interval from which the first filtered signal transitions a first threshold and until the first filtered signal transitions a second threshold;
measuring a second time period interval from which the second filtered signal transitions a third threshold and until the second filtered signal transitions a fourth threshold;
selecting the greatest of the first and second time period intervals;
comparing the selected time period interval to a plurality of limit values, the limit values related to a plurality of frequency bands; and
determining the frequency band of the input signal based on results from the comparing step.

12. The method of claim 11, wherein the input signal has an amplitude, the first and third threshold values have substantially a value that is the same, and the second and fourth threshold values have substantially a value that is the same and that differs from the value of the first and third thresholds by a selected amount.

13. The method of claim 11, wherein the first low-pass filter is a moving-average filter and the second low-pass filter is a moving-average filter having more taps than the first filter.

14. The method of claim 11, wherein the step of measuring the first time period interval comprises the step of counting a number of clock cycles from when the first filtered signal transitions the first threshold until the first filtered signal transitions the second threshold, and the step of measuring the second time period interval comprises the step of counting a number of clock cycles from when the second filtered signal transitions the third threshold until the second filtered signal transitions the fourth threshold.

15. A clock and data recovery device having:
a phase detector responsive to an input signal and having an output;
a first variable gain stage having an output and coupling to the output of the phase detector; and
an apparatus having an input node coupled to the output of the first variable gain amplifier, the apparatus comprising:
a first low-pass filter, coupled to the input node, having a first cutoff frequency and an output;
a second low-pass filter, coupled to the input node, having a second cutoff frequency less than the first cutoff frequency and an output;
a first time period estimator, having an output and an input coupled to the output of the first low-pass filter, configured to output a first time period measurement for samples From the output of the first low-pass filter to transition a first threshold and then transition a second threshold;
a second time period estimator, having an output and an input coupled to the output of the second low-pass filter, configured to output a second time period measurement for samples from the output of the second low-pass filter to transition a third threshold and then transition a fourth threshold; and
a frequency band discriminator configured to:
select the greater of the first and second time period measurements; and compare the selected time period measurement to a plurality of limit values, the limit values related to a plurality frequency bands;
determine the frequency band the input signal belongs based on the results from the comparison step;
determine, from a look-up table, a desired gain of the first variable train stage based on the frequency band of the input signal; and
apply the desired gain to the first variable gain stage.

16. The clock and data recovery device of claim 15 further having:
a second variable gain stage having an output and coupled to the output of the phase detector;
wherein the step of determining includes determining a desired gain of the second variable gain stage, and the apply the desired gain step includes applying the desired gain to the second variable stage.

17. The clock and data recovery device of claim 16 further having:
a first accumulator having an output and coupling to the output of the second variable gain stage;
a delay having an output and coupling to the output of the first accumulator;
a summer having an output and coupling to the output of the delay and the output of the first variable gain stage; and
a second accumulator having an output coupled to the output of the summer.

18. The clock and data recovery device of claim 16, wherein each of the variable gain stages includes a multiplier, and the desired gain from the look-up table for the corresponding variable Lain stage is applied to an input of the multiplier therein.

19. The clock and data recovery device of claim 16, wherein each of the variable gain stages includes a shift register, each shift register having a shift control for controlling the gain of the variable gain stage, and the desired gain from the look-up table for the corresponding variable gain stage is applied to the shift control therein.

20. The apparatus of claim 15, wherein the first and third thresholds have substantially a value that is the same and the second and fourth thresholds have substantially a value that is greater than the value of the first and third thresholds.

21. The apparatus of claim 15, wherein the first and third thresholds have substantially a value that is the same, and the second and fourth thresholds have substantially a value that is the same and that differs from the value of the first and third thresholds by an amount proportional to the desired gain of the first variable gain stage.

22. The apparatus of claim 15, wherein the time period measurement is a number of clock cycles occurring between transitions.

23. The apparatus of claim 15, wherein the first Low-pass filter is a moving-average filter and the second low-pass filter is a moving-average filter having more taps than the first filter.

24. The apparatus of claim 15, wherein the frequency band discriminator is implemented in a processor that also implements the first and second low-pass filters and the first and second time period estimators.

25. The apparatus of claim 15, wherein at least the phase detector, the first variable gain stage, and the apparatus are components of an integrated circuit.
